(19) United States
(12) Patent Application Publication
(10) Pub. No.: US 2007/0187340 A1
(43) Pub. Date: Aug. 16, 2007

(54) Process for the treatment of fluids originating from submarine oil fields

(75) Inventors: Pierluigi Oresti, Segrate-Milano (IT); Piera Agogliati, Rozzano-Milano (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: SAIPEM S.p.A., San Donato Milanese-Milano (IT)

(21) Appl. No.: 10/594,592

(22) PCT Filed: Feb. 7, 2005
(86) PCT No.: PCT/EP05/01260

§ 371 Date: Sep. 28, 2006

(30) Foreign Application Priority Data
Mar. 31, 2004 (IT) MI2004A000648

(51) Int. Cl. B01D 35/18; B01D 37/00

(52) U.S. Cl. 210/774; 210/806

(57) ABSTRACT

A process for treating on floating units fluid from submarine oil fields. The fluid is delivered to a high pressure separation stage in which the fluid is split into a light hydrocarbon gas phase, a water phase, and a hydrocarbon liquid phase. The light hydrocarbon gases are delivered to a gas reinjection compression unit, having at least two compression stages. The hydrocarbon liquid is delivered to one or more-further separation stages, operating at decreasing pressures, where the liquid is split into a light hydrocarbon gas phase, a water phase, and a liquid hydrocarbon phase. The light hydrocarbon gases are delivered to compression units including ejectors that use the compressed gas from the gas reinjection compression unit as driving fluid.

The present invention refers to a process for the treatment of fluids originating from submarine oil fields.

In the floating production units for the exploitation of the off-shore hydrocarbon fields, for instance those called FPSO (Floating Production Storage Off-Loading units), the fluid received from the submarine wells is collected in the inlet manifold (and pre-heated when necessary) and is sent to the high pressure (HP Separator) and/or test (Test Separator) gas/liquids separator, where the fluid at the inlet is split into a gas phase, consisting of light hydrocarbons, and two liquid phases, one of which consists mostly of water and the other substantially of hydrocarbon liquids.

The three streams are sent to the next treatments: the gas is sent to the reinjection gas compression unit (HP), where it is compressed to the requested conditions to use it as Gas Lift and/or Reinjection Gas; the oil, instead, is further treated until it matches the specific requirements (in particular it is stabilized and the water and salt quantities are reduced to match specification values).

During the treatment, the oil is heated and sent to further stages of gas/liquids separation at decreasing pressures (normally in two stages called Intermediate Pressure (IP) and Low Pressure (LP)) where, in both stages, the incoming fluid is split into a gas phase, consisting of light hydrocarbons, and two liquid phases, one of which is consists mostly of water and the other one substantially of hydrocarbon liquids. The gases that have been separated in these two stages might normally be sent to the torch (this is now a rare case due to environmental policies) or sent to a compression unit called “Flash Gas Compression” which has the task of recompressing the gas until it can be reunited with the gas coming from the high pressure stage.

The Flash Gas Compression unit is generally made up of compressors (centrifugal, screw or reciprocating) controlled by an electric drive, gas (gas engine or gas turbine) or steam (steam turbine) operated, which must be equipped with the relative auxiliary equipment (gas/oil separators, auxiliary machine coolers, lube oil, etc.). The main critical points related to the use of the Flash Gas Compression Unit on board of production floating units are the following:
Space occupied on the deck;
Risk connected with the project completion (delivery and installation delays);
Supply and installation costs;
Availability and reliability (as these are rotary machines their availability is much lower than that of static equipment);
Maintenance costs.
   A process has now been found that permits to reduce the problems of the current art processes by using, in the Flash Gas compression unit, an ejector which exploits the gas exiting from one of the high pressure compression stages as the driving fluid. The process, subject of the present invention, for the treatment of fluids originating from submarine oil fields, performed on board of floating units, includes the following stages:
delivering the fluid from the field to a high pressure gas/liquids separation stage (S-HP, where it is split into a gas phase substantially consisting of light hydrocarbon gases, and two liquid phases one of which consists mainly of water, the other substantially of hydrocarbon liquids;
delivering the light hydrocarbon gases, separated in the high pressure separation stage (S-HP), to a gas reinjection compression unit (C-HP) having at least two compression stages, preferably three;
delivering, after heating, the hydrocarbon liquid separated in the high pressure stage of separation (S-HP) to one or more further stages of gas/liquids separation operating at decreasing pressures (S-IP and/or S-LP), where, in each stage, it is split into a gas phase, essentially consisting of light hydrocarbon gases, and two liquid phases one of which mainly consists of water, the other mainly of hydrocarbon liquids;
delivering to a water treatment section the water which has been separated both in the first high pressure separation stage (S-HP) and in the decreasing pressure separation stage or stages;
delivering the light hydrocarbon gases which have been separated in the decreasing pressure separation stages to the corresponding compression units called “Flash Gas Jet Compression” (FGJC) thus recompressing said gases,
   and is characterized by the fact that, to recompress said gases in said compression units (FGJC) ejectors are employed, which use the compressed gas exiting from one of the compression stages of the reinjection gas compression unit (C-HP) as the driving fluid of each single ejector.

The driving fluid of each single ejector is preferably the compressed gas exiting from the second-last or the last compression stage of the reinjection gas compression unit (C-HP).

The further decreasing pressure compression stages are preferably a number of two, an intermediate pressure one (S-IP) and a low pressure one (S-LP).

The driving fluid of the ejector of the compression unit (FGJC-IP) of the hydrocarbon gas which has been separated in the intermediate pressure stage (IP) is preferably the compressed gas exiting from the last stage of the reinjection gas compression unit (C-HP). The driving fluid of the ejector of the compression unit (FGJC-LP) of the hydrocarbon gas which has been separated in the low pressure stage (LP) is preferably the compressed gas exiting from the last stage of the reinjection gas compression unit (C-HP).

Every compression stage of the reinjection gas compression unit (C-HP) preferably includes at least a biphasic separator to remove the liquid particles, a compressor and a heat exchanger to cool the compressed gas.

The compressed gas used as the driving fluid may be taken below the compressor or preferably before the cooling heat exchanger.

The recompressed gases exiting from the recompression units (FGJC-IP and FGJCLP) can be used as low pressure fuel gas (for instance to feed the boilers, to generate steam), as intermediate pressure fuel gas (for instance to feed gas turbines) or can be recycled at the intake of the reinjection gas compression unit (C-HP). With reference to the pressures of the driving fluid used in the process according to the present invention, it can be said that they are preferably comprised between 50 and 350 barg, or, better, between 100 and 250 barg.

With reference to the pressures of the gas/liquids separation stages it can be said that they depend essentially on the pressure of the fluid originating from the oil field.

With the process according to the present invention, it is however possible to perform the last separation stage at lower pressures (S-LP), even at sub-atmospheric pressure.

In more detail, typical operating pressures (but not binding) are comprised between 9 and 25 barg for the high pressure separator (S-HP), between 4 and 15 barg for the intermediate pressure separator (S-IP), between 0.5 and 1 barg for the low pressure separator (S-LP).

The main advantages of using the Flash Gas Jet Compressor on board a floating production unit, instead of the traditional Flash Gas compression system, are the following:
it is a static equipment, therefore characterized by a greater availability;
it requires less space;
it requires shorter fabrication and installation times and therefore presents smaller risks for the project completion time;
it has lower supply, installation and maintenance costs;
it makes it possible to control the operating pressure of the S-LP separator, thus optimizing the process of stabilization of the exiting hydrocarbon phase.

A further scope of the present invention is a production unit, characterized by the fact of containing a system for the treatment of the fluid originating from oil fields comprising a high pressure separator (S-HP) and at least a second lower pressure separator (S-IP or S-LP), a reinjection gas compression unit (C-HP) having at least two stages of compression and at least a compression unit called “Flash Gas Jet Compression” (FGJC) equipped with a suitable ejector.

The recompressed gases exiting from said compression unit (FGJC) can be used on board of the floating unit as low pressure fuel gases (for instance to feed boilers, to generate steam), as intermediate pressure fuel gases (for instance to feed gas turbines) or can be recycled at the intake of the high pressure compression unit.

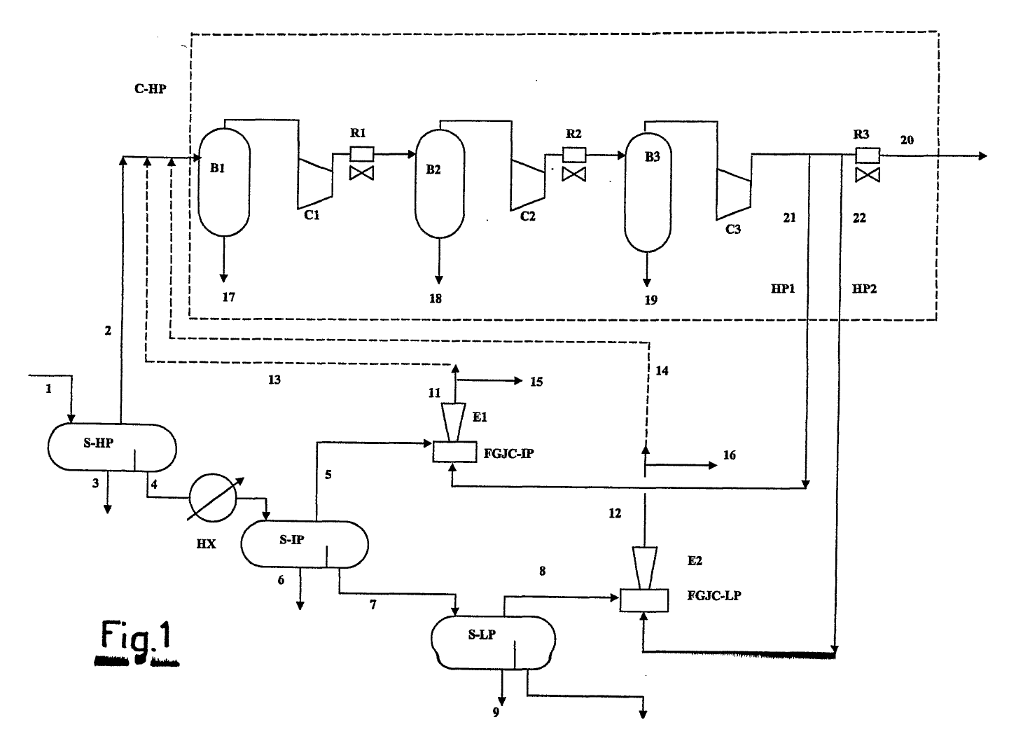

A realization according to the present invention is supplied with the help of FIG. 1.

The fluid originating from a submarine oil field is sent to a floating production unit equipped with a system for the treatment of said fluid.

Said fluid (1) might be preheated when necessary and sent to a gas/liquids high pressure separator (S-HP), thus separating the light hydrocarbon gases (2) and the two liquid phases of which one mainly consists of water (3) and the other substantially by hydrocarbon liquids (4).

The liquid phase (4) is heated in a suitable heat exchanger (HX) and sent to a second intermediate pressure separator (S-IP), thus separating the light hydrocarbon gases (5) and the two liquid phases of which one is mainly consisting of water (6) and the other substantially by hydrocarbon liquids (7).

The liquid phase (7) is sent to a third low pressure separator (S-LP), thus separating the light hydrocarbon gases (8) and the two liquid phases one of which mainly consists of water (9) and the other substantially of hydrocarbon liquids (10).

The gas phase (2), separated in (S-HP), is sent to a reinjection gas compression unit (C-HP), while each of the two gas phases exiting from the (S-IP) and (S-LP) separators is sent to a correspondent compression unit (respectively FGJC-IP and FGJCLP, called “Flash Gas Jet Compression”) to recompress said gases.

Every compression unit (FGJC) uses ejectors (E1 for the FGJC-IP and E2 for the FGJC-LP) for the recompression.

The gases exiting from the (FGJC) units, respectively (11) and (12), can be sent to the high pressure compression units (13) and (14) and/or used as fuel gases (of low and intermediate pressure), respectively (15) and (16).

The reinjection gas compression unit (C-HP) consists of three stages that comprise a biphasic separator (B1) to remove the liquid drops (17) that might have been carried by the gases (2), (13) and (14), a first compressor (C1), a heat exchanger (R1) which cools the compressed gas exiting from the first compressor, a second biphasic separator (B2) to remove possible condensed elements (18), a second compressor (C2), a second heat exchanger (R2) which cools the compressed gas exiting from the second compressor, a third biphasic separator (B3) to remove possible condensed elements (19), a third compressor (C3), a third heat exchanger (R3) which cools the compressed gas exiting from the third compressor before its use as reinjection gas or as gas lift (20).

The driving fluid of the ejector (E1) and/or of the ejector (E-2) is the gas compressed in the third stage of the high pressure compression unit (C-HP) before being cooled (21) and/or (22).

1-14. (canceled)

15. A process for treatment of fluids originating from a submarine oil field, performed on board of a floating unit, comprising:
delivering the fluid from the field to a high pressure gas/liquids separation stage, where the fluid is split into a gas phase substantially consisting of light hydrocarbon gases, and two liquid phases one of which mainly consists of water, the other substantially of hydrocarbon liquids;
delivering the light hydrocarbon gases, separated in the high pressure separation stage, to a reinjection gas compression unit having at least two compression stages;
delivering, after heating, the hydrocarbon liquid separated in the high pressure stage of separation to one or more further stages of gas/liquids separation operating at decreasing pressures, where, in each stage, the liquid is split into a gas phase essentially consisting of light hydrocarbon gases, and two liquid phases one of which mainly consists of water, the other mainly of hydrocarbon liquids;
delivering to a water treatment section the water separated both in the first high pressure separation stage and in the decreasing pressures separation stages;
delivering the light hydrocarbon gases, which have been separated in the decreasing pressure separation stages to corresponding compression units to recompress the gases, wherein to recompress gases in the compression units ejectors are employed, which use the compressed gas exiting from one of the compression stages of the reinjection gas compression unit as the driving fluid of each single ejector.

16. The process according to claim 15, wherein the driving fluid of each single ejector is the compressed gas exiting from the second-last or from the last compression stage of the reinjection gas compression unit.

17. The process according to claim 15, wherein the further decreasing pressure gas/liquids separation stages are in number of two, one at intermediate pressure and one at lower pressure.

18. The process according to claim 17, wherein the driving fluid of the ejector of the compression unit of the hydrocarbon gas separated in the intermediate pressure stage is the compressed gas exiting from the last stage of the reinjection gas compression unit.

19. The process according to claim 17, wherein the driving fluid of the ejector of the compression unit of the hydrocarbon gas separated in the lower pressure stage is the compressed gas exiting from the last stage of the reinjection gas compression unit.

20. The process according to claim 15, wherein each stage of compression of the reinjection gas compression unit comprises at least a biphasic separator to remove liquid particles, a compressor, and a heat exchanger to cool the compressed gas.

21. The process according to claim 20, wherein the compressed gas to be used as driving fluid is taken below the compressor.

22. The process according to claim 21, wherein the compressed gas to be used as driving fluid is taken below the compressor before the cooling heat exchanger.

23. The process according to claim 19, wherein the reinjection gas compression unit includes three compression stages.

24. The process according to claim 15, wherein the last stage of separation at decreasing pressures is performed at sub-atmospheric pressure.

25. The process according to claim 15, wherein the recompressed gases exiting from the compression units are used as fuel gases.

26. The process according to claim 15, wherein the recompressed gases exiting the compression units are sent to the reinjection gas compression unit.

27. A floating production unit comprising:
a treatment system for fluids originating from an oil field comprising a high pressure separator and at least a second lower pressure separator;
one reinjection gas compression unit having at least two compression stages; and
at least a compression unit equipped with a suitable ejector.

28. The process according to claim 15, performed in a floating production unit.
